(19) United States
(12) Patent Application Publication
(10) Pub. No.: US 2025/0139464 A1
(43) Pub. Date: May 1, 2025

(54) METHOD FOR PREDICTING ENERGY CONSUMPTION AND ELECTRONIC DEVICE

(71) Applicant: Fulian Precision Electronics (Tianjin) Co., LTD., Tianjin (CN)

(72) Inventors: YU-CHIH WANG, New Taipei (TW); Ting-Yu LIN, New Taipei (TW)

(21) Appl. No.: 18/640,407

(22) Filed: Apr. 19, 2024

(30) Foreign Application Priority Data
Oct. 26, 2023 (CN) 202311405508.5

(51) Int. Cl. G06N 5/022; G06N 20/00

(52) U.S. Cl. CPC G06N 5/022; G06N 20/00

(57) ABSTRACT

The present application provides a method for predicting energy consumption and an electronic device. The electronic device obtains energy efficiency data of a target device within a preset time period, and determines a plurality of influencing factors from the energy efficiency data according to a preset energy efficiency indicator and a feature extraction algorithm. The electronic device further determines a regression prediction model according to the plurality of influencing factors and the preset energy efficiency indicator, inputs the plurality of influencing factors into the regression prediction model and generates a first prediction value at each moment within the preset time period, and generates a trend graph of energy consumption corresponding to the preset time period according to a first predicted value at each moment. The present application is able to improve an efficiency of predicting energy consumption.

This application claims priority to Chinese Patent Application No. 202311405508.5 filed on Oct. 26, 2023, in China National Intellectual Property Administration, the contents of which are incorporated by reference herein.

### FIELD

The subject matter herein generally relates to an energy saving technology field, in particular, relates to a method for predicting energy consumption and an electronic device.

### BACKGROUND

In a process of producing products, large amount of production data will be generated in the assembly lines of a factory. Normally, the machines that consume the most energy are often determined by finding influencing factors with the largest energy consumption in a report, and the report is formed based on the production data of production cycles. In above method, on the one hand, all production data need to be input to generate the report, and due to the large amount of production data, a data processing efficiency is low, on the other hand, the above method is only able to find out the influencing factors with the largest energy consumption in the report, and unable to determine correlation values between the influencing factors and energy efficiency indicators, and unable to meet users' refined data prediction requirements.

In order to overcome above problem, in related technologies, the influencing factors that influence the largest energy consumption, and relevant factors are obtained from the production data, by professional technicians selecting and testing the production data. However, the above method requires high labor costs and time costs. Moreover, due to a diversity of the production data, if only relying on the professional technicians' experience, errors are likely to occur, and some production data cannot be tested or analyzed, thus affecting a detection accuracy.

### BRIEF DESCRIPTION OF THE DRAWINGS

Implementations of the present disclosure will now be described, by way of embodiment, with reference to the attached figures.

FIG. 1 is an application scenario diagram of an embodiment of a method for predicting energy consumption.

FIG. 2 is a flowchart of an embodiment of the method for predicting energy consumption.

### DETAILED DESCRIPTION

In order to facilitate understanding, some descriptions of concepts related to the embodiments of the present disclosure are given for reference.

It should be noted that in the present disclosure, “at least one” means one or more, and “multiple” means two or more than two. “And/or” describes an association relationship of associated objects, indicating that there can be three types of relationships, for example, A and/or B can mean that A is existing alone, A and B are existing simultaneously, and B is existing alone, and A, B can be singular or plural. The terms “first”, “second”, “third”, “fourth”, etc. (if any) in the description and claims of the present application and the drawings are used to distinguish similar objects, not to describe a particular order or sequence.

In a process of producing products, large amount of production data will be generated in the assembly lines of a factory. Normally, the machines that consume the most energy are often determined by finding influencing factors with the largest energy consumption in a report, and the report is formed based on the production data of production cycles. In above method, on the one hand, all production data need to be input to generate the report, and due to the large amount of production data, a data processing efficiency is low, on the other hand, the above method is only able to find out the influencing factors with the largest energy consumption in the report, and unable to determine correlation values between the influencing factors and energy efficiency indicators, and unable to meet users' refined data prediction requirements.

In order to overcome above problem, in related technologies, the influencing factors that influence the largest energy consumption, and relevant factors are obtained from the production data, by professional technicians selecting and testing the production data. However, the above method requires high labor costs and time costs. Moreover, due to a diversity of the production data, if only relying on the professional technicians' experience, errors are likely to occur, and some production data cannot be tested or analyzed, thus affecting a detection accuracy.

In order to solve the technical problem of low efficiency of energy consumption prediction in related technologies, embodiments of the present application provide a method for predicting energy consumption, an electronic device, and a storage media. An application scenario of the method for predicting energy consumption in the present application are described below.

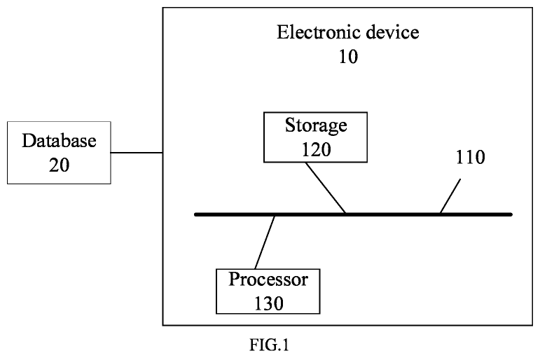

FIG. 1 illustrates an application scenario diagram of an embodiment of the method for predicting energy consumption. The method for predicting energy consumption provided by the embodiment of the present application is applied to an electronic device 10. The electronic device 10 is communicatively connected with a database 20.

The electronic device 10 is used to obtain and analyze data in the database 20. The electronic device 10 includes, but is not limited to, a storage 120 and at least one processor 130 that are communicatively connected to each other by a communication bus 110.

The database 20 may be an operational data storage (ODS) database, which can support daily operations of an enterprise and can store various types of data such as real-time production data, historical production data, and source data. The database 20 can support functions such as quick access, data integration, data cleaning, and data deduplication. The database 20 provides data support for the electronic device 10. In one embodiment of the present application, the database 20 can be built on an independent storage device or on a server or a server cluster, and practical applications are not limited to the above examples.

FIG. 1 is only an example of the electronic device 10 and does not constitute a limitation of the electronic device 10. The electronic device 10 may include more or fewer components than shown in the FIG. 1, or combine certain components, or different components, for example, the electronic device 10 may also include input and output devices, network access devices, etc.

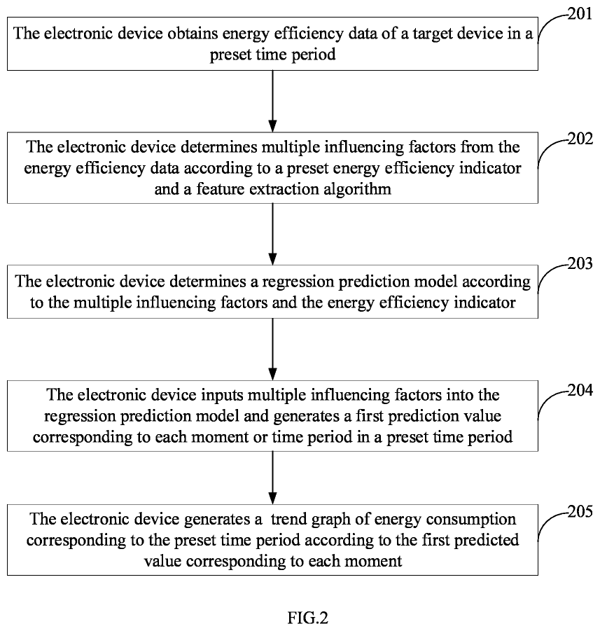

Referring to FIG. 2, FIG. 2 illustrates a flowchart of an embodiment of the method for predicting energy consumption provided by one embodiment of the present application. The method is applied to an electronic device (such as the electronic device 10 in FIG. 1). Depending on different needs, the order of steps in the flowchart can be changed and some steps can be omitted.

At block 201, the electronic device obtains energy efficiency data of a target device in a preset time period.

In some embodiments of the present application, the target device may be a product produced in a factory workshop, such as a refrigerator, a washing machine, a water heater, etc. The energy efficiency data refers to energy consumption values generated in a process of producing the target device, such as power consumption, amount of materials consumed, etc.

In some embodiments of the present application, the electronic device is able to receive a detection instruction input by the user. The electronic device responds to received detection instruction, and obtains energy consumption values generated in the process of producing the target device according to the energy consumption values. In one embodiment, the energy boundary values refer to a data detection range defined by the user, which is not limited by the present application.

In some embodiments of the present application, in order to obtain energy efficiency data with obvious periodic changes and avoid a phenomenon of cumulative increase in data, which will cause difficulty in subsequent modeling, after obtaining the production data, a first-order difference calculation can be performed on the production data to obtain the energy efficiency data.

In one embodiment, the production data is obtained in chronological order. Therefore, subtracting a first value at a first moment from second value at the second moment is the first-order difference calculation, and the first moment and the second moment are two consecutive moments, and the first moment precedes the second moment. By a method of the first-order difference calculation, the electronic device calculates the production data at each moment until all moments within the preset time period are traversed to obtain the energy efficiency data.

At block 202, the electronic device determines multiple influencing factors from the energy efficiency data according to a preset energy efficiency indicator and a feature extraction algorithm.

In some embodiments of the preset application, the energy efficiency indicator refers to standards for evaluation and measurement of energy utilization efficiency. In one embodiment, an energy efficiency ratio of an air conditioner is a ratio of a cooling capacity to actual power consumption, and the energy efficiency ratio is one of the indicators for measuring the energy utilization efficiency of the air conditioner. Similarly, an energy efficiency ratio of a television (TV) refers to a ratio of a power consumption of the TV to actual display power. The smaller the energy efficiency ratio, the higher the energy efficiency of the TV. In addition, there are different energy efficiency indicators such as washing machine energy efficiency level and computer energy efficiency level. These indicators are important standards used to evaluate and improve an energy efficiency of an equipment.

In another embodiment, the energy efficiency indicator may also refer to an energy utilization efficiency indicator, an energy saving rate, resource utilization efficiency, etc. The energy utilization efficiency indicator refers to a ratio of the amount of energy consumed to the amount of benefit energy obtained during an energy utilization process. The energy saving rate refers to an energy saving degree of an energy-consuming equipment. The higher the energy saving rate, the higher the energy utilization efficiency of the energy-consuming equipment. The resource utilization efficiency refers to a degree of effective utilization of resources, and the resource utilization efficiency can be improved by reducing waste and increasing recycling.

In some embodiments of the present application, the feature extraction algorithm may be one or more of a filter method, a wrapper method, and an embedding method. The feature extraction algorithm may be an algorithm used to evaluate a correlation between each feature and a target variable. In one embodiment, the electronic device determines the target variable in the feature extraction algorithm according to the energy efficiency indicator, that is, multiple energy consumption factors. Based on the feature extraction algorithm, the electronic device traverses each feature in the energy efficiency data, determines multiple target data from the energy efficiency data, and obtains the correlation values between the target data and multiple energy consumption factors. The electronic device determines multiple influencing factors from multiple target data according to a preset number and a preset sorting rule of the correlation values. In one embodiment, the preset number can be a number preset by the user, for example, 5, and the preset sorting rule can be an order rule of the correlation values from large to small. In an example, based on the sorting of the correlation values from large to small, the target data with the top 5 correlation values are obtained as the influencing factors.

At block 203, the electronic device determines a regression prediction model according to the multiple influencing factors and the energy efficiency indicator.

In some embodiments of the present application, the regression prediction model may be a model trained based on a linear regression model. In one embodiment, the electronic device obtains historical energy efficiency data as training data, extracts multiple feature data from the training data according to the preset energy efficiency indicator and the feature extraction algorithm; randomly inputs one or more feature data into a linear regression model, and constructs a regression prediction sub-model corresponding to the one or more feature data; obtains a second prediction value corresponding to one or more feature data according to one or more feature data and corresponding regression prediction sub-model; and calculates a score value of each regression prediction sub-model according to the second prediction value and the energy efficiency indicator; uses at least one regression prediction sub-model whose score value is greater than a preset threshold as the regression prediction model.

In an example, assume that five feature data are extracted from the training data, including feature data A, feature data B, feature data C, feature data D, and feature data E. These five feature data are randomly input into the linear regression model to construct the regression prediction sub-model corresponding to one or more feature data, and the regression prediction sub-model can include following equation:

$$Y 1 = b 0 + b 1 * feature data A ;$$

$$Y 2 = b 0 + b 1 * feature data B ;$$

$$Y 3 = b 0 + b 1 * feature data A + b2 * feature data B ;$$

$$Y 4 = b 0 + b 1 * feature data C + b2 * feature data D ;$$

$$Y 5 = b 0 + b 1 * feature data C + b2 * feature data D ;$$

$$Y 6 = b 0 + b 1 * feature data A + b2 * feature data B + b 3 * feature data C ;$$

$$Y 7 = b 0 + b 1 * feature data A + b2 * feature data C + b 3 * feature data E ;$$

$$Y 8 = b 0 + b 1 * feature data A + b2 * feature data B + b 3 * feature data C + b 4 * feature data D ;$$

$$Y 9 = b 0 + b 1 * feature data A + b2 * feature data B + b 3 * feature data C + b 4 * feature data E ;$$

In the above formulas, b0, b1, b2, b3 and b4 are constants. Based on one or more feature data and corresponding regression prediction sub-model, the second predicted value corresponding to one or more feature data is obtained, that is, Y1˜Y10. The above description are just examples. In actual applications, the regression prediction sub-model can include more situations, which will not be described one by one here.

In some embodiments of the present application, the score value of each regression prediction sub-model is calculated according to the second prediction value and the energy efficiency indicator. The energy efficiency indicator can be an actual value, and based on the second predicted value and the actual value output by the regression prediction sub-model, a regression sum of squares (SSR) and a total sum of squares (SST) can be calculated, and according to SSR and SST, a score value R² can be calculated, expressed by a formula: R²=SSR/SST.

In some embodiments of the present application, since the score value is used to evaluate a fitting degree of a model, the regression prediction sub-model can be selected according to the score value, and at least one regression predictor model whose score value is greater than the preset threshold can be screened out. In one embodiment, the preset threshold can be set according to an actual situation, for example, 0.8, which is not limited by the application.

In some embodiments of the present application, if there is no regression prediction sub-model with a score value greater than the preset threshold, updated training data is obtained again and the linear regression model is retrained by using the updated training data to obtain the updated regression prediction sub-model. In one embodiment, data that does not conform to a preset data type is removed from historical energy efficiency data and the updated training data is obtained again. The data type that does not comply with the preset data type may refer to not comply with a data detection range corresponding to energy boundary values.

In some embodiments of the present application, if the electronic device receives instruction information input by the user, and the instruction information includes a preset number of models stored in the electronic device, that is, a certain number (for example, 10) of the regression prediction sub-models is stored in the electronic device, however, the number of regression prediction sub-models with score values greater than the preset threshold does not meet the preset model number of 10, then the electronic device obtains the regression prediction sub-models with score values less than or equal to the preset threshold, and use the updated training data to train the regression prediction sub-models with score values less than or equal to the preset threshold to obtain updated regression prediction sub-models, thus making the number of regression prediction sub-models with score values greater than the preset threshold satisfies the preset number of models.

In some embodiments of the present application, after multiple regression prediction sub-models are stored in the electronic device, the electronic device determines the regression prediction model from the multiple regression prediction sub-models according to multiple influencing factors and energy efficiency indicators. If receiving a prediction request from a user equipment, the electronic device determines at least one influencing factor from multiple influencing factors based on the prediction request, and determines one regression prediction sub-model including at least one influencing factor as the regression prediction model according to at least one influencing factor and the energy efficiency indicator.

In one embodiment, the prediction request carries the influencing factors selected by the user, and based on the influencing factors and energy efficiency indicators selected by the user, the determined regression prediction sub-model is used as the regression prediction model.

In some embodiments of the present application, if a prediction request is not received, the electronic device determines a regression prediction sub-model including multiple influencing factors as a regression prediction model based on multiple influencing factors and the energy efficiency indicators.

In some embodiments of the present application, if the prediction request is not received, the electronic device determines the regression prediction sub-model including multiple influencing factors as the regression prediction model based on multiple influencing factors and the energy efficiency indicators. In one embodiment, the multiple regression prediction sub-models stored in the electronic device have priorities. For example, a priority of the regression prediction sub-model corresponding to 5 influence factors is greater than a priority of the regression prediction sub-model corresponding to 4 influence factors. If not receiving the prediction request, the electronic device uses the regression prediction sub-model corresponding to the 5 influencing factors as the regression prediction model (such as above Y10). If not receiving the prediction request and 4 influencing factors are included, the regression prediction sub-model corresponding to the four influencing factors is used as the regression prediction model (such as above Y8).

In other embodiments of the present application, in addition to above method of training the regression prediction model described in above embodiments, the regression prediction model can also be trained using a machine learning algorithm or a deep learning algorithm. For example, the regression prediction model can be trained using a random forest regression algorithm, which is not limited in the present application.

At block 204, the electronic device inputs multiple influencing factors into the regression prediction model and generates a first prediction value corresponding to each moment or time period in a preset time period.

In some embodiments of the present application, after the regression prediction model is determined, the multiple influencing factors can be input into the regression prediction model to obtain prediction results. Since the multiple influencing factors are influencing factors corresponding to each moment in the preset time period, the prediction results output by the regression prediction model includes the first predicted value corresponding to each moment in the preset time period.

At block 205, the electronic device generates a trend graph of energy consumption corresponding to the preset time period according to the first predicted value corresponding to each moment.

In some embodiments of the present application, in order to intuitively display the difference between the first predicted value and a standard value to the user, the trend graph of energy consumption may include a curve formed by the first predicted value at each moment in the preset time period and a curve formed by the energy efficiency indicators. In one embodiment, the curves in the trend graph of energy consumption can be marked with different colors or different curve types, which is not limited by the present application.

In other embodiments of the present application, the trend graph of energy consumption can also be a bar chart, a pie chart, a line chart, a scatter plot, a histogram, or a box plot, which are not limited by the present application.

In the embodiment of the present application, the energy efficiency data corresponding to the target device that needs to be analyzed in a preset time period is obtained; and according to the preset energy efficiency indicators and the feature extraction algorithm, multiple influencing factors are determined from the energy efficiency data; and according to the multiple influencing factors and the energy efficiency indicators, the regression prediction model is determined, so that the first prediction value corresponding to each moment in the preset time period is generated according to the regression prediction model, thereby obtaining an energy consumption trend chart. The present application can improve the efficiency and accuracy of energy consumption prediction. In addition, the present application can perform intelligent analysis and intelligent modeling of data on the production line, eliminating the need for professional technicians to select influencing factors and manual testing, reducing labor costs.

Referring to FIG. 1 again, in one embodiment, the storage 120 may be an internal memory of the electronic device 10, that is, the storage 120 is built into the electronic device 10.

In other embodiments, the storage 120 may also be an external memory of the electronic device 10, that is, the storage 120 a memory external to the electronic device 10.

In some embodiments, the storage 120 is used to store program codes and various data, and realize high-speed and automatic access to programs or data during the operation of the electronic device 10.

In one embodiment, the storage 120 may include random access memory, and may also include a non-volatile memory, such as hard disk, plug-in hard disk, smart memory card (SMC), secure digital (SSD) card, Flash Card, at least one disk storage device, flash memory device, or other volatile solid-state storage device.

The computer-readable storage medium may be the internal memory of the first machine described in the above embodiments, such as the hard disk or memory of the first machine. The computer-readable storage medium may also be an external storage device of the first machine, such as a plug-in hard disk, a smart memory card (SMC), or a Secure Digital (SD) card, Flash Card, etc.

In one embodiment, the processor 130 may be a central processing unit (CPU), or other general-purpose processor, a digital signal processor (DSP), or an application specific integrated circuit (ASIC), a Field-Programmable Gate Array (FPGA) or other programmable logic devices, discrete gate or transistor logic devices, discrete hardware components, etc. The general-purpose processor may be a microprocessor or the processor 130 may be any other conventional processor, etc.

If the program codes and various data in the storage 120 are implemented in the form of software functional units and sold or used as independent products, they can be stored in a computer-readable storage medium. Based on this understanding, the present application implements all or part of the processes in the above embodiment methods, such as the method for predicting energy consumption, and can also be completed by instructing relevant hardware by a computer program. The computer program can be stored in a computer-readable storage. When the computer program is executed by the processor, the steps of each of the above method embodiments can be implemented. In one embodiment, the computer program includes computer program code, which may be in the form of source code, object code form, executable file or some intermediate form, etc. The computer-readable medium may include: any entity or device capable of carrying the computer program code, recording media, U disk, mobile hard disk, magnetic disk, optical disk, computer memory, read-only memory (ROM), etc.

It can be understood that the module division described above is a logical function division, and there may be other division methods in actual implementation. In addition, each functional module in each embodiment of the present disclosure may be integrated into a same processing unit, or each module may exist separately physically, or two or more modules may be integrated into a same unit. The above-mentioned integrated modules can be implemented in the form of hardware, or in the form of hardware plus software function modules.

The above description only represents some embodiments of the present disclosure and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A method for predicting energy consumption, the method comprising:
obtaining energy efficiency data of a target device within a preset time period;
determining a plurality of influencing factors from the energy efficiency data according to a preset energy efficiency indicator and a feature extraction algorithm;
determining a regression prediction model according to the plurality of influencing factors and the preset energy efficiency indicator;
inputting the plurality of influencing factors into the regression prediction model and generating a first prediction value at each moment within the preset time period;
generating a trend graph of energy consumption corresponding to the preset time period according to a first predicted value at each moment.

2. The method for predicting energy consumption according to claim 1, further comprising:
obtaining historical energy efficiency data as training data;
extracting a plurality of feature data from the training data according to the preset energy efficiency indicator and the feature extraction algorithm;
randomly inputting one or more feature data into a linear regression model, and constructing regression prediction sub-models corresponding to the one or more feature data;
obtaining a second prediction value corresponding to the one or more feature data according to the one or more feature data and corresponding regression prediction sub-models;
calculating a score value of each of the regression prediction sub-models according to the second prediction value and the energy efficiency indicator;
determining at least one regression prediction sub-model whose score value is greater than a preset threshold as the regression prediction model.

3. The method for predicting energy consumption according to claim 2, further comprising:
in response that no regression prediction sub-model has a score value that is greater than the preset threshold, regaining updated training data, and retraining the linear regression model by using the updated training data, and obtaining an updated regression prediction sub-model.

4. The method for predicting energy consumption according to claim 3, wherein regaining updated training data comprises:
obtaining the updated training data by removing data that does not conform to a preset data type from the historical energy efficiency data.

5. The method for predicting energy consumption according to claim 1, wherein determining a plurality of influencing factors from the energy efficiency data according to a preset energy efficiency indicator and a feature extraction algorithm, comprises:
determining a plurality of energy consumption factors related to the energy efficiency indicator;
determining target data from the energy efficiency data according to the plurality of energy consumption factors and the feature extraction algorithm;
obtaining correlation values between the target data and the plurality of energy consumption factors;
determining the plurality of influencing factors from the target data according to a preset number and a preset sorting rule of the correlation values.

6. The method for predicting energy consumption according to claim 1, wherein determining a regression prediction model according to the plurality of influencing factors and the energy efficiency indicator, comprises:
in responses that a user's prediction request is received, determining at least one influencing factor from the plurality of influencing factors according to the prediction request; and determining a regression prediction sub-model comprising the at least one influencing factor as the regression prediction model according to the at least one influencing factor and the energy efficiency indicator;
in responses that no user's prediction request is received, determining the regression prediction sub-model comprising the plurality of influencing factors as the regression prediction model according to the plurality of influencing factor and the energy efficiency indicator.

7. The method for predicting energy consumption according to claim 1, wherein obtaining energy efficiency data of a target device within a preset time period, comprises:
obtaining production data of the target device during a production process;
performing a first-order difference calculation on the production data, and obtaining the energy efficiency data.

8. The method for predicting energy consumption according to claim 1, wherein the trend graph of energy consumption comprises a curve formed by the first predicted value at each moment in the preset time period and a curve formed by the energy efficiency indicator.

9. An electronic device comprising:
a processor; and
a non-transitory storage medium, coupled to the processor, that stores a plurality of instructions, which cause the processor to:
obtain energy efficiency data of a target device within a preset time period;
determine a plurality of influencing factors from the energy efficiency data according to a preset energy efficiency indicator and a feature extraction algorithm;
determine a regression prediction model according to the plurality of influencing factors and the preset energy efficiency indicator;
input the plurality of influencing factors into the regression prediction model and generate a first prediction value at each moment within the preset time period;
generate a trend graph of energy consumption corresponding to the preset time period according to a first predicted value at each moment.

10. The electronic device according to claim 9, wherein the plurality of instructions are further configured to cause the processor to:
obtain historical energy efficiency data as training data;
extract a plurality of feature data from the training data according to the preset energy efficiency indicator and the feature extraction algorithm;
randomly input one or more feature data into a linear regression model, and construct regression prediction sub-models corresponding to the one or more feature data;
obtain a second prediction value corresponding to the one or more feature data according to the one or more feature data and corresponding regression prediction sub-models;
calculate a score value of each of the regression prediction sub-models according to the second prediction value and the energy efficiency indicator;
determine at least one regression prediction sub-model whose score value is greater than a preset threshold as the regression prediction model.

11. The electronic device according to claim 10, wherein the plurality of instructions are further configured to cause the processor to:
in response that no regression prediction sub-model has a score value that is greater than the preset threshold, regain updated training data, and retrain the linear regression model by using the updated training data, and obtain an updated regression prediction sub-model.

12. The electronic device according to claim 11, wherein the plurality of instructions are further configured to cause the processor to:
obtain the updated training data by removing data that does not conform to a preset data type from the historical energy efficiency data.

13. The electronic device according to claim 9, wherein the plurality of instructions are further configured to cause the processor to:
determine a plurality of energy consumption factors related to the energy efficiency indicator;
determine target data from the energy efficiency data according to the plurality of energy consumption factors and the feature extraction algorithm;
obtain correlation values between the target data and the plurality of energy consumption factors;
determine the plurality of influencing factors from the target data according to a preset number and a preset sorting rule of the correlation values.

14. The electronic device according to claim 9, wherein the plurality of instructions are further configured to cause the processor to:
in responses that a user's prediction request is received, determining at least one influencing factor from the plurality of influencing factors according to the prediction request; and determining a regression prediction sub-model comprising the at least one influencing factor as the regression prediction model according to the at least one influencing factor and the energy efficiency indicator;
in responses that no user's prediction request is received, determining the regression prediction sub-model comprising the plurality of influencing factors as the regression prediction model according to the plurality of influencing factor and the energy efficiency indicator.

15. The electronic device according to claim 9, wherein the plurality of instructions are further configured to cause the processor to:
obtain production data of the target device during a production process;
perform a first-order difference calculation on the production data, and obtain the energy efficiency data.

16. The electronic device according to claim 9, wherein the trend graph of energy consumption comprises a curve formed by the first predicted value at each moment in the preset time period and a curve formed by the energy efficiency indicator.

17. A non-transitory storage medium having stored thereon instructions that, when executed by at least one processor of an electronic device, causes the least one processor to execute instructions of a method for predicting energy consumption, the method comprising:
obtaining energy efficiency data of a target device within a preset time period;
determining a plurality of influencing factors from the energy efficiency data according to a preset energy efficiency indicator and a feature extraction algorithm;
determining a regression prediction model according to the plurality of influencing factors and the preset energy efficiency indicator;
inputting the plurality of influencing factors into the regression prediction model and generating a first prediction value at each moment within the preset time period;
generating a trend graph of energy consumption corresponding to the preset time period according to a first predicted value at each moment.

18. The non-transitory storage medium according to claim 17, wherein the method further comprises:
obtaining historical energy efficiency data as training data;
extracting a plurality of feature data from the training data according to the preset energy efficiency indicator and the feature extraction algorithm;
randomly inputting one or more feature data into a linear regression model, and constructing regression prediction sub-models corresponding to the one or more feature data;
obtaining a second prediction value corresponding to the one or more feature data according to the one or more feature data and corresponding regression prediction sub-models;
calculating a score value of each of the regression prediction sub-models according to the second prediction value and the energy efficiency indicator;
determining at least one regression prediction sub-model whose score value is greater than a preset threshold as the regression prediction model.

19. The non-transitory storage medium according to claim 18, wherein the method further comprises:
in response that no regression prediction sub-model has a score value that is greater than the preset threshold, regaining updated training data, and retraining the linear regression model by using the updated training data, and obtaining an updated regression prediction sub-model.

20. The non-transitory storage medium according to claim 19, wherein regaining updated training data comprises:
obtaining the updated training data by removing data that does not conform to a preset data type from the historical energy efficiency data.
